(19) United States
(12) Patent Application Publication
(10) Pub. No.: US 2026/0329960 A1
(43) Pub. Date: Oct. 22, 2026

(54) Method For Generating Feedback Information On Mathematical Problem-Solving Processes

(71) Applicant: ZEZEDU CORP., Gyeonggi-do (KR)

(72) Inventor: Jujin LEE, Gyeonggi-do (KR)

(73) Assignee: ZEZEDU CORP., Gyeonggi-do (KR)

(21) Appl. No.: 19/106,510

(22) PCT Filed: Nov. 15, 2024
(86) PCT No.: PCT/KR2024/018055

§ 371 Date: Feb. 25, 2025

(30) Foreign Application Priority Data
Nov. 15, 2023 (KR) 10-2023-0157823
Nov. 15, 2024 (KR) 10-2024-0163012

(51) Int. Cl. G06F 17/11; G06V 30/40

(52) U.S. Cl. CPC G06F 17/11; G06V 30/40

(57) ABSTRACT

Disclosed is a method for generating feedback information on a mathematical problem solution process, which is performed by a computing device according to an embodiment of the present disclosure. The method may include: acquiring user input information related to a mathematical problem solution; analyzing the mathematical problem solution process based on the acquired user input information by using a pretrained artificial intelligence model; and generating feedback information for the mathematical problem solution based on the analysis.

### DESCRIPTION

### Technical Field

The present disclosure relates to a method for generating feedback information on a mathematical problem solution process.

### Background Art

A mathematics subject is a subject in which a composition of a problem is logically complex and a curriculum linkage ratio between grades high, so it is very difficult to make an accurate diagnosis compared to other subjects. Since a score is only a superficial phenomenon, a method is required which can determine whether a logical flow from a problem to a correct answer can be accurately understood in mathematics. Korean Patent Unexamined Publication No. 10-2022-0070888 (May 31, 2022) discloses Effective Math Concept Learning and Problem Solving Textbook.

This invention is a result applied by the support of “2024 Global Startup Commercialization Support Project’ of Gyeonggi-do and Gyeonggi-do Economic Science Promotion Agency.

### DISCLOSURE

### Technical Problem

The present disclosure has been made in an effort to provide a method which analyzes a solution method of a student in a mathematical problem solution process in real time, and deviates from checking only a correct answer, and provides a diagnosis and a feedback for a solution process itself.

Further, the present disclosure has been made in an effort to provide a method in which since a mathematical problem solution ability and an error type are different for each student, a customized feedback is provided according to a learning level of an individual student, and a solution process is automatically analyzed by using an artificial intelligence model and a feedback is generated to simplify and efficienate grading and a feedback task of a teacher.

Meanwhile, a technical object to be achieved by the present disclosure is not limited to the above-mentioned technical object, and various technical objects can be included within the scope which is apparent to those skilled in the art from contents to be described below.

### Technical Solution

Disclosed is a method for generating feedback information on a mathematical problem solution process, which is performed by a computing device according to an embodiment of the present disclosure in order to realize the above-described objects. The method may include: acquiring user input information related to a mathematical problem solution; analyzing the mathematical problem solution process based on the acquired user input information by using a pretrained artificial intelligence model; and generating feedback information for the mathematical problem solution based on the analysis.

In an embodiment, the acquiring of the user input information related to the mathematical problem solution may include at least one of acquiring user input information input through an app or a web, or acquiring user input information to scan a paper including information related to the mathematical problem solution.

In an embodiment, the acquiring of the user input information related to the mathematical problem solution may include distinguishing characters, numbers, and mathematical symbols in the acquired user input information; recognizing the distinguished character by using a character recognition model; recognizing the distinguished number by using the character recognition model; and recognizing the distinguished mathematical symbol by using the character recognition model.

In an embodiment, the analyzing of the mathematical problem solution process based on the acquired user input information by using the pretrained artificial intelligence model may include sequentially dividing the solution process based on the acquired user input information; and analyzing the sequentially divided solution process in response to a Rubric item by using the pretrained artificial intelligence model.

In an embodiment, the Rubric item may include at least one of a problem understanding, a solution approach, a calculation accuracy, or a final answer derivation.

In an embodiment, the pretrained artificial intelligence model may be trained based on an operation of acquiring training solution process data; an operation of sequentially dividing the training solution process data; an operation of acquiring the Rubric item which is an evaluation criterion for each of the sequentially divided training solution process data; and an operation of predicting whether the sequentially divided training solution process data satisfies the Rubric item.

In an embodiment, the pretrained artificial intelligence model may include at least one of a first model for measuring an ability of identifying a purpose and a condition of a problem; a second model for evaluating a solution access approach or a logical development; a third model for evaluating a calculation accuracy for each of the sequentially divided training solution process data; or a fourth model for determining whether a finally derived correct answer satisfies a requirement of the problem.

In an embodiment, the generating of the feedback information for the mathematical problem solution based on the analysis may include generating feedback information for the sequentially divided solution process based on a result analyzed in response to the Rubric item.

In an embodiment, the generating of the feedback information for the sequentially divided solution process based on the result analyzed in response to the Rubric item may include at least one of generating feedback information for a solution process which needs to be improved in response to the Rubric item; or generating the feedback information for the sequentially divided solution process by granting a partial score according to a satisfactory degree for each Rubric item.

In an embodiment, the analyzing of the mathematical problem solution process based on the acquired user input information by using the pretrained artificial intelligence model may include analyzing whether the character included in the user input information is a character directly related to the mathematical problem solution or an additional character not directly related to the mathematical problem solution.

In an embodiment, the analyzing of the mathematical problem solution process based on the acquired user input information by using the pretrained artificial intelligence model may include, when the character included in the user input information is the character directly related to the mathematical problem solution, identifying a language character; identifying a formula associated with the character among formulas included in the mathematical problem solution process by considering a system of the identified language; and generating analysis information based on semantic information of the character and the identified formula.

In an embodiment, the analyzing of the mathematical problem solution process based on the acquired user input information by using the pretrained artificial intelligence model may include, when the character is the additional character not directly related to the mathematical problem solution, generating the analysis information based on a remaining part other than the additional character.

In an embodiment, the method may further include generating a problem related to the mathematical problem solution to be user customized by considering the analyzed mathematical problem solution process.

Disclosed is a computer program stored in a non-transitory computer readable medium according to an embodiment of the present disclosure in order to realize the above-described objects. When the computer program is executed by one or more processors, the computer program may allow the one or more processors to perform the following operations for generating feedback information on a mathematical problem solution process, and the operations may include: an operation of acquiring user input information related to a mathematical problem solution; an operation of analyzing the mathematical problem solution process based on the acquired user input information by using a pretrained artificial intelligence model; and an operation of generating feedback information for the mathematical problem solution based on the analysis.

In an embodiment, the operation of acquiring the user input information related to the mathematical problem solution may include an operation of distinguishing characters, numbers, and mathematical symbols in the acquired user input information; an operation of recognizing the distinguished character by using a character recognition model; an operation of recognizing the distinguished number by using the character recognition model; and an operation of recognizing the distinguished mathematical symbol by using the character recognition model.

In an embodiment, the operation of analyzing the mathematical problem solution process based on the acquired user input information by using the pretrained artificial intelligence model may include an operation of sequentially dividing the solution process based on the acquired user input information; and an operation of analyzing the sequentially divided solution process in response to a Rubric item by using the pretrained artificial intelligence model.

In an embodiment, the operation of generating the feedback information based on the analyzed solution process may include an operation of generating feedback information for the sequentially divided solution process based on a result analyzed in response to the Rubric item.

In an embodiment, the operation of analyzing the mathematical problem solution process based on the acquired user input information by using the pretrained artificial intelligence model may include an operation of analyzing whether the character included in the user input is a character directly related to the mathematical problem solution or an additional character not directly related to the mathematical problem solution.

In an embodiment, the operation may further include an operation of providing a problem related to the solution to be user customized by considering the analyzed solution process.

Disclosed is a computing device according to an embodiment of the present disclosure in order to realize the above-described objects. The device may include: at least one processor; and a memory, and the at least one processor may be configured to acquire user input information related to a mathematical problem solution; analyze the mathematical problem solution process based on the acquired user input information by using a pretrained artificial intelligence model; and generate feedback information for the mathematical problem solution based on the analysis.

In an embodiment, the at least one processor may be configured to distinguish characters, numbers, and mathematical symbols in the acquired user input information; recognize the distinguished character by using a character recognition model; recognize the distinguished number by using the character recognition model; and recognize the distinguished mathematical symbol by using the character recognition model.

In an embodiment, the at least one processor may be configured to sequentially divide the solution process based on the acquired user input information; and analyze the sequentially divided solution process in response to a Rubric item by using the pretrained artificial intelligence model.

In an embodiment, the at least one processor may be configured to generate the feedback information for the sequentially divided solution process based on a result analyzed in response to the Rubric item.

In an embodiment, the at least one processor may be configured to analyze whether a character included in a user input is a character directly related to the mathematical problem solution or an additional character not directly related to the mathematical problem solution.

In an embodiment, the at least one processor may be additionally configured to provide a problem related to the solution to be user customized by considering the analyzed solution process.

### Advantageous Effects

According to the present disclosure, a pre-trained artificial intelligence model learns various error patterns which can be generated in a mathematical problem solution process to clearly present specific problems and improvement directions shown in a solution of a student, thereby providing delicate learning feedback information.

Further, according to the present disclosure, the student is allowed to modify and improve a wrong solution process through an immediate and customized feedback, and the student can personally complement a non-understood part in real time while solving a problem, so an understanding level of a learning process can also be increased.

Further, according to the present disclosure, since each step of the solution process can be analyzed through an artificial intelligence model and a score can be given, grading and partial score giving for each step are possible in addition to giving a score according to whether there is a correct answer, and this can assist the student to specifically determine which part should be further complemented in the solution process in addition to an overall understanding level.

Further, according to the present disclosure, the student allows the teacher to individually determine a learning state to focus on teaching by departing from a grading task which is repeated and requires a lot of time to design a learning direction based on statistics for an error type or a understanding lack part which the student frequently commits.

Meanwhile, the effects of the present disclosure are not limited to the above-mentioned effects, and various effects can be included within the scope which is apparent to those skilled in the art from contents to be described below.

### DESCRIPTION OF DRAWINGS

FIG. 1 is a block diagram of a computing device for generating feedback information on a mathematical problem solution process according to an embodiment of the present disclosure.

FIG. 2 illustrates an exemplary structure of an artificial intelligence based model according to an embodiment of the present disclosure.

FIG. 3 is a flowchart illustrating a process of generating feedback information on a mathematical problem solution process according to an embodiment of the present disclosure.

FIG. 4 is a diagram for describing an operation of acquiring user input information related to a mathematical problem solution according to an embodiment of the present disclosure.

FIG. 5 is a diagram for describing an operation of analyzing a solution process for user input information acquired by using a pre-trained artificial intelligence model according to an embodiment of the present disclosure.

FIG. 6 is a diagram for describing an operation of generating feedback information according to an embodiment of the present disclosure.

FIG. 7 is a diagram schematically illustrating a result of giving a partial score to a mathematical problem solution by a user interface according to an embodiment of the present disclosure.

FIG. 8 is a diagram schematically illustrating a user interface that provides a synthetics result on a mathematical problem solution process according to an embodiment of the present disclosure.

FIG. 9 is a diagram schematically illustrating a user interface related to a dashboard which may confirm a learning history for each student according to an embodiment of the present disclosure.

FIG. 10 is a simple and normal schematic view of an exemplary computing environment in which the embodiments of the present disclosure may be implemented.

### MODE FOR INVENTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

FIG. 1 is a block diagram of a computing device for generating feedback information on a mathematical problem solution process according to an embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 150 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

The techniques described in this specification can be used in other networks as well as the networks mentioned above.

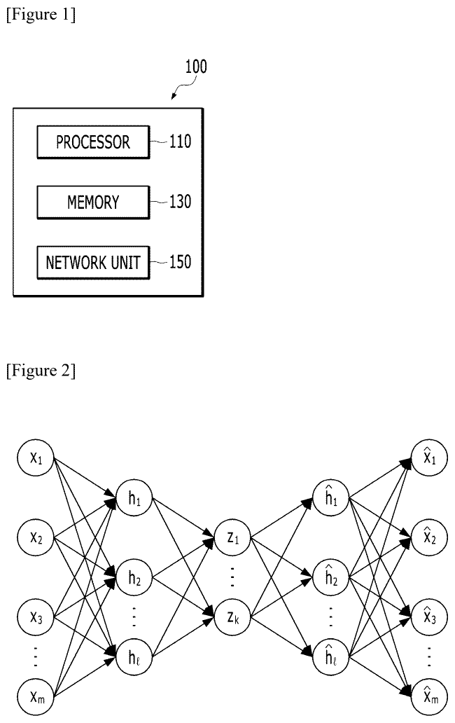

FIG. 2 is a conceptual diagram illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

The present disclosure relates to a method of performing a breast composition evaluation technique of breast ultrasound, and quantification of a breast tissue component and a glandular tissue component, and grade classification by using deep learning technology from a breast ultrasound image. Further, the present disclosure is a technology for software which performs automatic quantification and grade classification of a breast tissue component and a glandular tissue component in ultrasound.

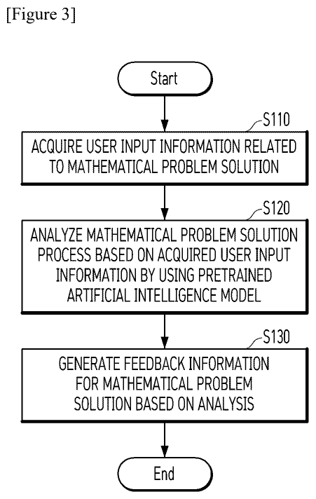

FIG. 3 is a flowchart illustrating a process of generating feedback information on a mathematical problem solution process according to an embodiment of the present disclosure. Meanwhile, the method for generating the feedback information for the mathematical problem solution process described below may be performed by the computing device 100. For reference, a user mentioned below may include a student, a participant, etc., who solve a mathematical problem provided by the computing device 100.

According to an embodiment of the present disclosure, referring to FIG. 3, the method for generating the feedback information for the mathematical problem solution process may include a step (S110) of acquiring user input information related to a mathematical problem solution, a step (S120) of analyzing the mathematical problem solution based on the acquired user input information by using a pre-trained artificial intelligence model, and a step (S130) of generating the feedback information for the mathematical problem solution based on the analysis. Meanwhile, the computing device 100 acquires the user input information related to the mathematical problem solution acquired through various approaches, and analyzes the mathematical problem solution process by using an artificial intelligence model to provide a feedback stepwise.

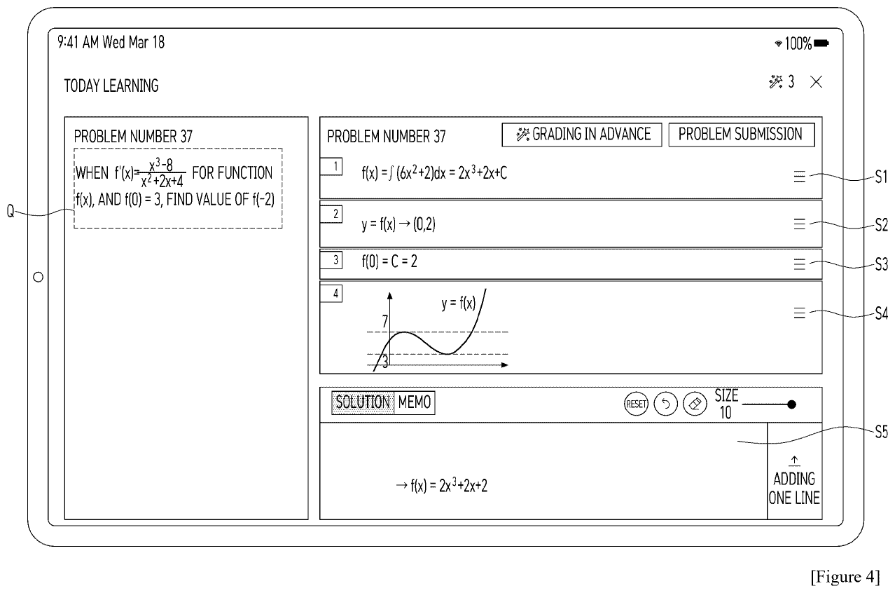

FIG. 4 is a diagram for describing an operation of acquiring user input information related to a mathematical problem solution according to an embodiment of the present disclosure.

According to an embodiment of the present disclosure, the computing device 100 may acquire user input information related to a mathematical problem solution (S110). As an example, the user input information related to the mathematical problem solution may be information including characters, numbers, and mathematical symbols created by handwriting. Hereinafter, for convenience of description, an embodiment is described by assuming that the characters included in the user input information related to the mathematical problem solution are Korean, but the present disclosure is not limited thereto, and the characters may include various languages (e.g., English, Japanese, Chinese, etc.). For example, the user input information related to the mathematical problem solution may include information in which a user creates a commentary on the problem or inputs a calculation process in a formula form. For example, the computing device 100 may acquire user input information input through an app or a web. As an example, the computing device 100 may acquire user input information for the user to solve a mathematical problem through a web application or a mobile app installed in user equipment. The user may directly input a process of solving the mathematical problem in a digital format by using the user equipment (e.g., a smartphone, a tablet PC, etc.), and the computing device 100 may acquire the user input information input through the user equipment. The computing device 100 acquire the user input information through a mobile app, a tablet app, a tablet web, a PC web, etc. According to an embodiment, referring to FIG. 4, the computing device 100 may provide a mathematical problem Q to the user equipment before step S110. The user may input solution processes (S1 to S5) through a touch display of the user equipment while solving a mathematical problem output to the user equipment (e.g., the mobile web or application). As an example, the user may sequentially input information related to the mathematical problem solution through the user equipment as in S1 to S5 illustrated in FIG. 4. Further, the computing device 100 may also sequentially divide the solution process for the user input information acquired for the acquired user input information as in S1 to S5.

As another example, the computing device 100 may also acquire user input information of scanning a paper including information related to the mathematical problem solution. For example, the user may create the mathematical problem solution in the paper, and the computing device 100 may also acquire information of scanning the paper as the user input information. For example, the user may create the mathematical problem solution in the paper stepwise, and the computing device 100 may acquire an image in which the corresponding paper is photographed with a mobile camera or scanner as the user input information.

According to an embodiment, the computing device 100 may distinguish characters, numbers, and mathematical symbols by using a character recognition model in order to accurately recognize information related to the mathematical problem solution in the acquired user input information. Here, the characters may include variables, function symbols, text descriptions, etc. Further, the mathematical symbols may include +, −, =, \hat{ }, fractions, parentheses, subscripts, indexes, etc. For example, the character recognition model may include an optical character recognition (OCR) model, an intelligent character recognition (ICR) model, etc. First, the computing device 100 may distinguish elements included in the user input information for each type. Since the user input information related to the mathematical problem solution includes general texts (characters), numbers, mathematical symbols (operators and symbols), etc., the computing device 100 may distinguish the elements included in the user input information for each type in order to individually recognize the general texts (characters), numbers, mathematical symbols (operators and symbols), etc. For example, when the user input information related to the mathematical problem solution includes an equation such as f(x)=x\hat{ }2+2x+1, the computing device 100 may distinguish “f” and “x” as characters, “\hat{ }” and “+” as mathematical symbols, and “2” and “1” as numbers. The computing device 100 classifies the characters, the numbers, and the mathematical symbols to allow the character recognition model to recognize the elements included in the user input information even more accurately. For example, the computing device 100 may distinguish the characters, the numbers, and the mathematical symbols in the user input information acquired through a network such as CNN or R-CNN.

For example, the computing device 100 may recognize each of the classified characters, numbers, and mathematical symbols by using the character recognition model. For example, the computing device 100 may allow the character recognition model for recognizing the characters, numbers, and mathematical symbols to be trained by using a specialized dataset. For example, the specialized dataset may be data including various styles such as handwriting and printing, and reflected with a feature of a symbol or a number frequently used in the mathematical problem solution. Further, the computing device 100 may secure diversity of training data of the character recognition model through various types of modifications including rotation, distortion, noise addition, etc. Further, the character recognition model may be designed to include layers specialized for recognitions of the characters, the numbers, and the symbols, respectively, or for a specific layer to optimize a recognition performance for each category. Further, the character recognition model may also be trained by using a contextual flow (e.g., a pattern in which the symbol or number is located at a specific position). As an example, the character recognition model has a recognition capability specialized to each element while learning each of the character, the number, and the mathematical symbol to better understand mathematical meanings such as a variable, a constant, and an operator other than only a general character. Further, the character recognition model may clearly distinguish similar characters (e.g., “1” and “I”, and “0” and “O”) without confusing the similar characters, and reduce a recognition error due to a wrong symbol interpretation (e.g., “−” and “=”). Further, the character recognition model is trained to accurately recognize various handwriting, sizes, or slopes of handwriting to reduce an error for information input in an actual problem solution. In other words, the character recognition model may acquire the user input information related to the mathematical problem solution, and classify the acquired user input information into a character, a number, and a mathematical symbol, and individually recognize the classified character, number, and mathematical symbol. For example, the character recognition model may recognize that “x” is the variable, and accurately determine that “+” is an operation symbol. Further, when the number and the operator “+” are shown in sequence, the character recognition model may interpret this as an addition symbol. Further, when a symbol such as an exponential operation (e.g., “\hat{ }”) is used jointly with the number, the character recognition model determines the number as the index operation to reduce a misunderstanding which may occur in a problem solution process.

According to an embodiment, the computing device 100 may recognize the distinguished characters, numbers, and mathematical symbols by using a single character recognition model. Further, the computing device 100 may recognize each of the distinguished characters, numbers, and mathematical symbols by using a plurality of character recognition models. Alternatively, the computing device 100 may also recognizes the distinguished characters by using a first optical recognition model. For example, the first optical recognition model may be an optical recognition model which may be based on a language model to recognize various languages, and may complement a context of a text through an analysis of a morphology. An optical recognition model solution approach which reflects a language structure and a context may show a high performance, in particular, a long sentence or syntax analysis. Further, the computing device 100 may also recognize the distinguished numbers by using a second optical recognition model. For example the second optical recognition model may be an optical recognition model for recognizing the numbers. Since a simple pattern recognition is important in the numbers, a wrong recognition (e.g., a confusion of “1” and “l”) may be reduced by using the second optical recognition model specialized to recognize the numbers. The second optical recognition model may include a simple pattern matching model specialized to the numbers, and a network structure reflecting number characteristics. Further, the computing device 100 may also recognize the distinguished mathematical symbols by using a third optical recognition model. The third optical recognition model may be an optical recognition model for recognizing the mathematical symbols. Since symbol and location information are important in recognizing an equation, the third optical recognition model may include a model that learns a relative location of the symbol. For example, a character recognition model that recognizes the mathematical symbols may be a model trained to understand fractions, parentheses, subscripts, indexes, etc.

Alternatively, the computing device 100 may also perform a text recognition in the acquired user input information by using an intelligent character recognition (ICR) model. For example, the intelligent character recognition (ICR) model may perform preprocessing for the acquired user input information for an accurate recognition. Here, the acquired user input information may also be collected in an image form. The intelligent character recognition (ICR) model may perform preprocessing such as increasing a resolution of an image, removing background noise, adjusting a contrast, etc. Further, the intelligent character recognition (ICR) model may distinguish characters, numbers, and mathematical symbols in the acquired user input information. For example, the intelligent character recognition (ICR) model may also distinguish a sentence and an equation by referring a location rule and a context which are generally shown within Korean sentences. Further, the intelligent character recognition (ICR) model may also distinguish the sentence and the equation by referring location rules and contexts which are generally shown within various languages. The intelligent character recognition (ICR) model may be trained to recognize various languages, numbers, equations, special characters, etc. For example, when the user input information related to the mathematical problem solution is Korean, the intelligent character recognition (ICR) model may recognize the user input information, and convert the recognized user input information into a digital text. Further, since the numbers are important factors in the mathematical problem solution, the intelligent character recognition (ICR) model ma separately recognize the numbers, and prevent the recognized numbers from being confused with other characters, and also accurately recognize continued numbers. Further, since mathematical symbols such as ‘+’, ‘−’, ‘=’, ‘√’, etc., have different forms from a general text, the intelligent character recognition (ICR) model may be trained to distinguish the mathematical symbols. In particular, in the case of the formula, since the equation is shown in a form in which various symbols and numbers are combined, the intelligent character recognition (ICR) model may entirely recognize the symbols and the numbers, and accurately distinguish and analyze the symbols and the numbers. For example, the intelligent character recognition (ICR) model recognizes the characters, the numbers, and the mathematical symbols, and then reviews a context of a recognized text to check whether a sentence is normally recognized. For example, the intelligent character recognition (ICR) model may review whether an equation of “3x+2=11” is recognized according to a mathematical rule, and detect and modify an error when the numbers and the symbols are listed in a wrong order. Further, intelligent character recognition (ICR) model may correct a part which does not fit a context by using a language model jointly. For example, when ‘x’ is misrecognized as ‘x’ which is the mathematical symbol other than the character in a sentence “an area of a rectangle is 3×2=11”, the language model analyzes a context to detect an error and modify 3×2=11 to 3x+2=11.

According to an embodiment of the present disclosure, the computing device 100 may analyze a solution process based on the acquired user input information by using a pre-trained artificial intelligence model (S120). First, the computing device 100 may sequentially divide the solution process based on the acquired user input information. As an example, the computing device 100 may set a division criterion based on a step or a logical flow which occurs in the mathematical problem solution process. For example, the solution process may be sequentially divided in an approach of following each operation step in an equation problem. For example, the computing device 100 may sequentially divide the solution process for the user input information by dividing the solution process into a problem understanding, a solution approach setting, a calculation, a correct answer derivation, etc. As an example, the computing device 100 may determine a condition of a problem and identify required information. The computing device 100 may sequentially divide the solution process based on the acquired user input information by analyzing a text of the problem, and identifying a required equation or reorganizing conditions. As an example, a process of selecting a method suitable for a problem pattern such as differential, integral, equation solution, etc., and establishing an initial equation is included, and the computing device 100 may sequentially divide the solution process based on the acquired user input information by setting a solution approach. The computing device 100 may sequentially divide the solution process for the user input information based on a calculation step which is a process of developing an equation, or performing an operation or obtaining an intermediate result. Further, the computing device 100 may sequentially divide the solution process for the user input information based on a correct answer derivation step including a process of reviewing a calculated value, and checking whether a unit or a condition is correct, and driving a final answer. For example, the mathematical problem may be [Find a rectangular area. width: 3x+2, height: x−1, and x=3]. The computing device 100 may acquire width=3(3)+2=11, height=3−1=2, and rectangular area=width*height=11*2=22 by substituting x=3 as user input information related to mathematical problem solution. Here, the computing device 100 may sequentially divide a solution process for the user input information acquired as in acquire width=3(3)+2=11, height=3−1=2, and rectangular area=width*height=11*2=22 by substituting the solution process for the user input information acquired by using the pretrained artificial intelligence model. Alternatively, the computing device 100 may sequentially divide the solution process for the user input information acquired based on the problem patterns (e.g., differential, integral, equation solution, etc.). The computing device 100 may an operation and an access solution approach performed in each step by sequentially dividing the solution process for the user input information acquired as described above. For example, referring to FIG. 4, the computing device 100 may sequentially divide the solution process based on the acquired user input information like S1 to S5.

According to an embodiment, the computing device 100 may analyze the sequentially divided solution process in response to a Rubric item by using the pre-trained artificial intelligence model. For example, the computing device 100 may use the pretrained artificial intelligence model in order to check whether the sequentially divided solution process satisfies the Rubric item. As an example, the Rubric item may include at least one of the problem understanding, the solution approach, calculation accuracy, or the final answer derivation. The above-described matter is just an example and the present disclosure is not limited thereto. For example, the mathematical problem is [Find a rectangular area. width: 3x+2, height: x−1, and x=3], and the divided solution process is intended to be described based on an embodiment in which Step 1: width=3(3)+2=11 and height=3−1=2 by substituting x=3, and Step 2: rectangular area=width*height=11*2=22. For example, in a problem understanding item, it may be evaluated whether the user accurately interprets and reflects a given condition in the problem. The computing device 100 may determine whether to correctly substitute x=3 given in Step 1 in the problem understanding item among the Rubric items by using the pretrained artificial intelligence model. Further, the computing device 100 may analyze whether the user correctly understands the condition of the problem (a process of substituting an x value into the width and the height) by comparing a problem content input by using the pretrained artificial intelligence model and an initial step of the solution process. Further, in the solution approach item, it may be evaluated whether a solution approach suitable for a problem is applied. The computing device 100 may evaluate whether the user appropriately uses a formula (a geometric area calculation method) of multiplying the width and the height in order to obtain the rectangular area by using the pretrained artificial intelligence model. Further, in the calculation accuracy item, it may be evaluated whether an equation calculation of each step is accurately performed. The computing device 100 may evaluate whether a substitution and a calculation in Step 1 and Step 2 are accurate by using the pretrained artificial intelligence model. For example, the computing device 100 may evaluate whether calculation such as 3(3)+2=11 and 3−1=2 are correct, or a calculation such as 11*2=22 is correct by using the pretrained artificial intelligence mode. Further, in the final answer derivation item, it may be devaluated whether a correct answer is derived in a last step of the problem solution. The computing device 100 may evaluate whether the finally derived answer is correct as the rectangular area, that is, a final answer is accurately calculated as 22 by using the pretrained artificial intelligence model. For example, the computing device 100 may set the sequentially divided solution process as an input of the pretrained artificial intelligence model, and the pretrained artificial intelligence model may predict how each sequentially divided solution process satisfies a specific Rubric item.

According to an embodiment, the above-described pretrained artificial intelligence model may be trained based on an operation of evaluating each data of the sequentially divided training solution process based on the sequentially divided training solution process data and the Rubric item. First, the computing device 100 receives training solution process data for training the pretrained artificial intelligence model. For example, the training solution process data may include data for model training by collecting various patterns problems and solution examples. Further, the training solution process data may all steps required for an actual solution process, and each step may be linked with a specific Rubric criterion. Further, the computing device 100 may sequentially divide the acquired training solution process data. For example, the computing device 100 may divide the solution process for each problem pattern, and classify various steps based on a purpose and a solution method performed by each step. As an example, a differential problem may be divided into steps such as “equation organization→differential result application→result organization”. Further, the computing device 100 may acquire the Rubric item which is an evaluation criterion for each of the sequentially divided training solution process data. For example, the computing device 100 sets a Rubric criterion including at least one of problem understanding, a solution approach, calculation accuracy, or final answer derivation suitable for a training purpose for each step to evaluate how well the solution process satisfies the corresponding criterion. For example, in the “problem understanding” step, the Rubric item for various evaluation criteria for evaluating whether core information of the problem is accurately determined and whether the calculation is accurately made in the “calculation accuracy” step may be acquired. Further, the computing device 100 may train the pretrained artificial intelligence model to evaluate each of the sequentially divided training solution process data based on the sequentially divided training solution process data acquired as above, and the Rubric item. The pretrained artificial intelligence model may be trained to predict how the sequentially divided training solution process data satisfies the specific Rubric item.

According to another embodiment, the pretrained artificial intelligence model may also be a model trained through supervised learning. For example, the computing device 100 may determine the training solution process data. Further, the computing device 100 may sequentially divide the training solution process data. A label indicating whether a criterion corresponding to the Rubric item is satisfied (satisfied or dissatisfied) or each step may be granted to the sequentially divided training solution process data. Further, the computing device 100 may also acquire information (e.g., a keyword, an operation structure, appropriateness of a development approach, etc.) indicating whether a reference is satisfied by extracting a feature of any one of the problem understanding, the solution approach, the calculation accuracy, or the final answer derivation. Further, the computing device 100 may set an optimized model for each specific Rubric item in order to predict a stepwise feedback of the problem. For example, the computing device 100 may use an RNN or Transformer based model suitable for a text analysis with respect to the Rubric item of evaluating the problem understanding. Further, since an operation verification is important in the calculation accuracy, the computing device 100 may use a classification model for verifying the equation. Further, the computing device 100 may be trained by using a loss function (e.g., a cross entropy loss) in order to reduce a difference between a value predicted by the pretrained artificial intelligence model for each Rubric item and an actual label. The loss function may determine a learning direction so as to reduce the error when the pretrained artificial intelligence model predicts whether the reference is satisfied. The pretrained artificial intelligence model may output whether the criterion of each Rubric item is satisfied as a prediction score or a probability value when receiving new solution process data. For example, the pretrained artificial intelligence model may show a result such as “this step satisfies 85% in the problem understanding item”, and quantitatively provide whether the criterion is satisfied. Further, the pretrained artificial intelligence model may provide a part which needs to be improved to a learner as a feedback based on a prediction result for whether each Rubric criterion is satisfied. For example, a feedback such as “since the calculation accuracy is satisfied 60%, please, review an operation of the corresponding step again” may be generated. Further, the pretrained artificial intelligence model may grant a partial score according to a degree at which Rubric-specific criterion is satisfied.

According to yet another embodiment, the pretrained artificial intelligence model may include sub models specialized to the Rubric items, respectively. For example, the sub model may include a first model for measuring a capability of identifying a purpose and a condition of the problem. Further, the sub model may include a second model which evaluates a solution access approach or a logical development. Further the sub model may include a third model for evaluating the calculation accuracy for each of the sequentially divided training solution process data. Further, the sub model may include a fourth model which determines whether the finally derived correct answer satisfies a requirement of the problem. The sub models may be formed in a form of sharing a common intermediate layer, and sending and receiving mutual information. For example, the intermediate layer may learn characteristics of a plurality of Rubric items by applying a multi-task learning approach, and reflect an inter-item association. For example, since the problem understanding and the solution approach have a high mutual association, the intermediate layer shares information of the two items to increase a prediction accuracy. Information between items having a high relevancy may be efficiently used while independently evaluating each Rubric item through such a structure. For example, the pretrained artificial intelligence model receives new solution data to predict how the criterion is satisfied for each Rubric item.

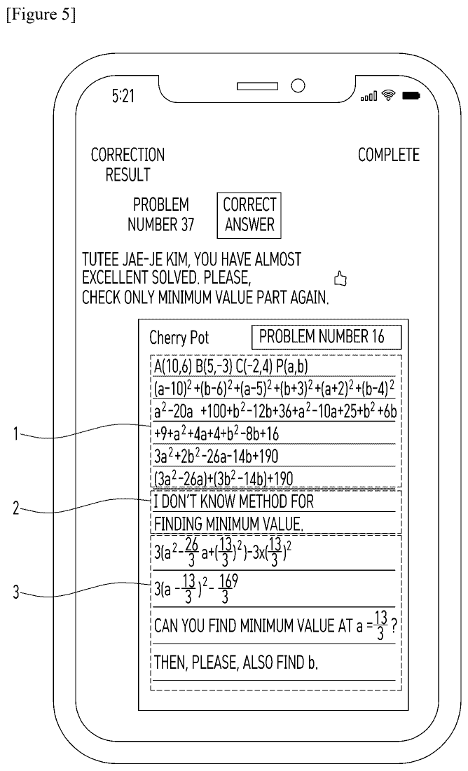

FIG. 5 is a diagram for describing an operation of analyzing a solution process for user input information acquired by using a pre-trained artificial intelligence model according to an embodiment of the present disclosure.

According to an embodiment, the computing device 100 may analyze whether a character included in a user input is a character directly related to the mathematical problem solution or an additional character not directly related to the mathematical problem solution. For example, referring to FIG. 5, the acquired user input information may include first input information 1 and second input information 2. The computing device 100 may analyze whether the first input information 1 and the second input information 2 is the character directly related to the mathematical problem solution or the additional character not directly related to the mathematical problem solution. For reference, third input information 3 is feedback information. For example, referring to FIG. 5, the computing device 100 may analyze the second input information 2 in which the character included in the user input is the additional character not directly related to the mathematical problem solution by using the pretrained artificial intelligence model. For example, the computing device 100 may identify the additional character in the acquired user input information by using a natural language processing (NLP) and a context analysis technique. For example, the computing device 100 may classify sentences based on a context. The computing device 100 first analyzes the character included in the user input to separate main words related to the problem solution (e.g., a differential, a maximum value, a minimum value, a function, a pole value, etc.), and unrelated words. As an example, a sentence such as the second input information 2 corresponding to “I don't know a method for obtaining a minimum value” includes core terms directly related to the mathematical problem solution, but the computing device 100 may recognize that the core terms are a user description on the context or an expression showing a difficulty. Further, the computing device 100 may determine an intent of each sentence. As an example, the computing device 100 may check whether each sentence is a problem solution intent, a question or a request, or a general opinion not related to a solution. For example, the computing device 100 may interpret the second input information 2 corresponding to “I do not know the method for obtaining the minimum value” as an assistance request or opinion statement other than a calculation or logic directly related to the problem solution. As another example, the computing device 100 may also analyze whether the character included in the user input is the character directly related to the mathematical problem solution or the additional character not directly related to the mathematical problem solution by considering keyword filtering, pattern recognition, location based analysis, semantic similarity evaluation, etc. As yet another example, when the character included in the user input information is “when log is applied~?”, it may be determined that the corresponding input information is the character directly related to the mathematical problem solution. Meanwhile, the computing device 100 may determine input information including the equation and the mathematical symbol as the character directly related to the mathematical problem solution like the first input information 1.

For example, when the character included in the user input is the character directly related to the mathematical problem solution, the computing device 100 may identify a language of the character. As an example, the computing device 100 may identify whether the character included in the user input is Korean or other languages (e.g., English, Japanese, Chinese, etc.) by using the natural language processing (NLP) technology. Through this, the text and the formula may be more accurately associated with each other by reflecting a grammar and a structure for each language (a system of a language) in a subsequent analysis process. Further, the computing device 100 may identify a formula associated with the character among formulas included in the solution process by considering the identified system of the language. For example, in the case of Korean, when the expression such as “when log is applied to~” appears, this may be interpreted as a meaning of applying a log operation to the formula. On the contrary, in English, an expression such as “Apply log to~” is used as the same meaning. By reflecting the system each language as such, a sentence pattern meaning a specific operation (e.g., log, differential, or integral), and an association with the corresponding formula may be analyzed based thereon. Further, the computing device 100 may generate analysis information based on semantic information and an identified formula of the character. The computing device 100 may determine with which an operation, a function, or a variable name mentioned in the text is associated through a semantic analysis. For example, when there is a text such as “log is applied”, the computing device 100 may identify the associated formula by searching a formula or a variable related to a log function, and generate the analysis information based on the identified formula. Further, in the case of English, the computing device 100 may identify that the variable x and the log function are associated with each other in a text such as “Apply log to x”, and generate the analysis information based on the identified formula. For reference, the analysis information may be input data input into the pretrained artificial intelligence model.

For example, when the character is the additional character not directly related to the mathematical problem solution, the computing device 100 may generate the analysis information based on a remaining part other than the additional character. Referring back to FIG. 5, except for the second input information 2 in which the character is the additional character not directly related to the mathematical problem solution, the computing device 100 may analyze a mathematical problem solution process by inputting the first input information 1 into the pretrained artificial intelligence model.

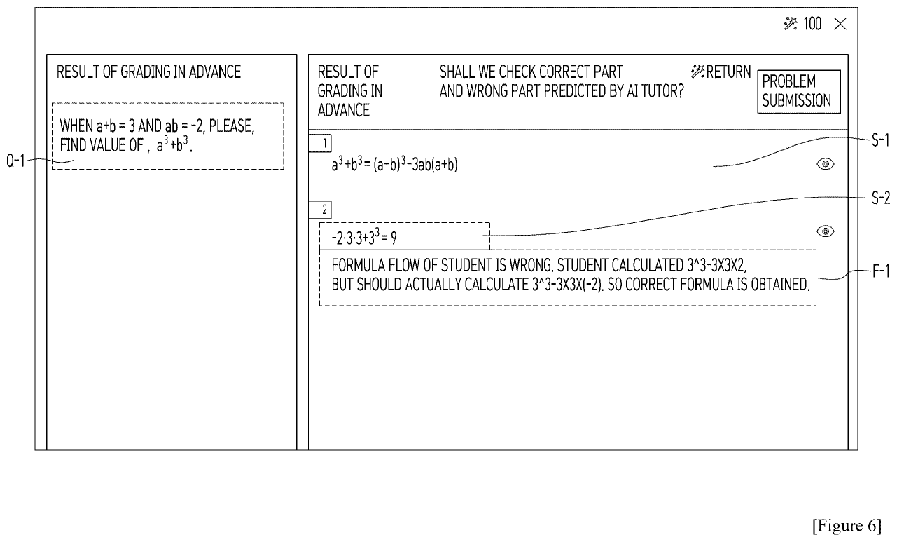

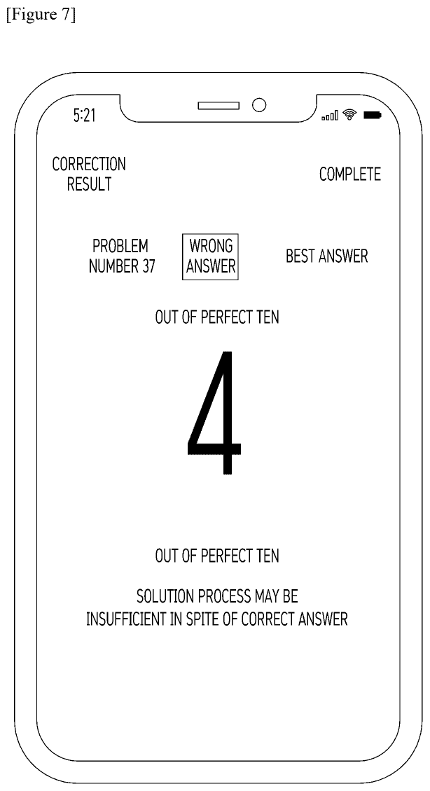

FIG. 6 is a diagram for describing an operation of generating feedback information according to an embodiment of the present disclosure and FIG. 7 is a diagram schematically illustrating a result of giving a partial score to a mathematical problem solution by a user interface according to an embodiment of the present disclosure.

According to an embodiment of the present disclosure, the computing device 100 may generate feedback information for the mathematical problem solution based on the analysis (S130). For example, the computing device 100 may generate the feedback information for the mathematical problem solution based on whether the Rubric item which is an analysis result of the pretrained artificial intelligence model being satisfied. For example, when the Rubric item which is the analysis result of the pretrained artificial intelligence model is not satisfied 100%, the computing device 100 may generate the feedback information for the mathematical problem solution in response to the item which is not satisfied. As an example, the feedback information may include a feedback related to an error pattern corresponding to the Rubric item, a quantitative feedback, a qualitative feedback, etc. Further, the computing device 100 may generate feedback information for a sequentially divided solution process based on a result analyzed in response to the Rubric item. For example, the computing device 100 may generate feedback information for a solution process which needs to be improved in response to the Rubric item. Alternatively, the computing device 100 may also generate feedback information on a mathematical problem solution based on the analysis by using the language model. For example, the computing device 100 may generate a prompt based on the analysis result of the pretrained artificial intelligence model, the Rubric item, and the sequentially divided solution process in order to generate the feedback information by using the language model.

For example, the computing device 100 may generate specific feedback information such as “the law of distribution is not correctly applied in this step” or “a sign is wrongly used in an addition” when the specific Rubric item is not satisfied. Further, the computing device 100 may provide a description for each Rubric item with a language which is easily understood by the user. For example, the computing device 100 may generate the feedback information of deriving learning by adding a feedback such as “The problem understanding is accurate and a solution approach is also correct. However, an answer is wrong because there is an error in a final calculation. Please, check a calculation once again”. Further, the computing device 100 may also generate feedback information such as “since the calculation accuracy is satisfied 60%, please, review the operation in the corresponding step again” based on a prediction result indicating whether each Rubric criterion is satisfied. For example, referring to FIG. 6, the computing device 100 may acquire first-1 user input information S-1 and first-2 user input information S-2 related to the mathematical problem solution in response to a first-1 mathematical problem Q-1. Further, the computing device 100 may analyze the mathematical problem solution process based on the acquired user input information by using the pretrained artificial intelligence model. Further, the computing device 100 may sequentially divide the solution process based on the acquired user input information, and analyze the solution process in response to the Rubric item by using the pretrained artificial intelligence model. The computing device 100 may generate feedback information for a solution process which needs to be improved in response to the Rubric item. For example, the computing device 100 may generate the feedback information for the solution process which needs to be improved in response to the Rubric item like first-1 user input information, based on an analysis result of the pretrained artificial intelligence model for the first-2 user input information S-2.

Further, the computing device 100 may generate feedback information for the sequentially divided solution process by granting a partial score according to a satisfactory degree for each Rubric item. The computing device 100 may generate a score which the learner receives in each step by quantitatively providing the partial score for each Rubric item. For example, when the problem understanding and the solution approach are satisfied, but the error occurs in the calculation, the computing device 100 may reflect this to the partial score. For example, referring to FIG. 7, the computing device 100 grants the partial score for the analyzed solution process, and adds the Rubric item to which the partial score is granted to generate the feedback information.

According to an embodiment, when the additional character not directly related to the mathematical problem solution satisfies a predetermined condition, the computing device 100 may also generate the feedback information based on the additional character. The predetermined condition may include a case of including a keyword of requesting feedbacks such as I don't know, please help, it is difficult, etc. For example, referring back to FIG. 5, the second input information2 is the additional character not directly related to the mathematical problem solution, but satisfies the predetermined condition, so the computing device 100 inputs the second input information 2 into the pretrained artificial intelligence model to generate feedback information for the additional character. At this time, the pretrained artificial intelligence model may generate the feedback information by an approach which does not provide all solution processes for the second input information 2, but provides only a partial help to the user. The pretrained artificial intelligence model may not provide all solutions for the second input information 2, but provide required partial information (e.g., a formula, a hint, etc., to be used next, etc.) for the user to thick about a next solution process. Through this, the user may obtain an additional clue for solving the problem, and personally continue problem solving.

According to an embodiment of the present disclosure, the computing device 100 may provide a problem related to a solution to be user customized by considering the analyzed solution process. For example, the computing device 100 analyzes the user input information related to the mathematical problem solution to identify understanding an error, a weak point, and an insufficient concept which occur in a specific problem solution process. As an example, when it is confirmed that the user repeatedly makes a calculation mistake in a problem solution process, or cannot understand a specific mathematical principle (e.g., addition and multiplication rule of a fraction), the computing device 100 may determine a part which the user should improve based thereon, and generate a problem related to the solution to be user customized. For example, the computing device 100 may also generate a customized problem by considering the solution process analyzed according to the Rubric item. When there are a lot of wrong answers for the problem understanding item among the Rubric items according to the analysis result, the computing device 100 may generate a problem which helps the user who suffers difficulty in problem understanding to clearly understand a core condition of the problem. For example, the computing device 100 provides a problem in which the condition is more simply reconfigured or a presented problem by emphasizing an important condition to help the user to determine a nature of the problem, and then generate a customized problem which may increase an understanding degree through a problem in which the condition is gradually complicated. Further, when there are a lot of wrong answers for the solution approach among the Rubric items according to the analysis result, the computing device 100 may generate a problem to which a specific strategy or concept required for the problem solution may be applied. For example, the computing device 100 previously notifies a formula frequently used in a specific pattern of problem or presents a problem of deriving a solution method through a hint to generate a problem to learn understanding and a logical development approach for the solution process. Further, when there are a lot of wrong answers for the calculation accuracy among the Rubric items according to the analysis result, the computing device 100 may generate a problem which requires a complicated operation starting from a problem in which a calculation process is comparatively simple for enhancement of the calculation accuracy. For example, when a mistake frequency appears in the addition or the multiplication, the computing device 200 provides a problem which focuses on the corresponding operation to generate a problem so as to improve the calculation accuracy through repeated learning. Further, when there are a lot of wrong answers for the final answer derivation among the Rubric items according to the analysis result, the computing device 100 may provide a problem which requires an answer verification in an intermediate solution process, or generate a problem for increasing an attention in a final step. As a result, the user may be allowed to reduce the mistake in the last step of the solution, and examine and learn an entire flow of the solution process. The customized problem generation approach for each Rubric item may help the user to clearly determine an insufficient part of the user, and complement a weak point through repeated learning. Since a feedback in each step is provided in real time, the feedback may significantly contribute to maximize a learning effect, and finally comprehensively enhancing a mathematical thinking skill and a problem solving ability.

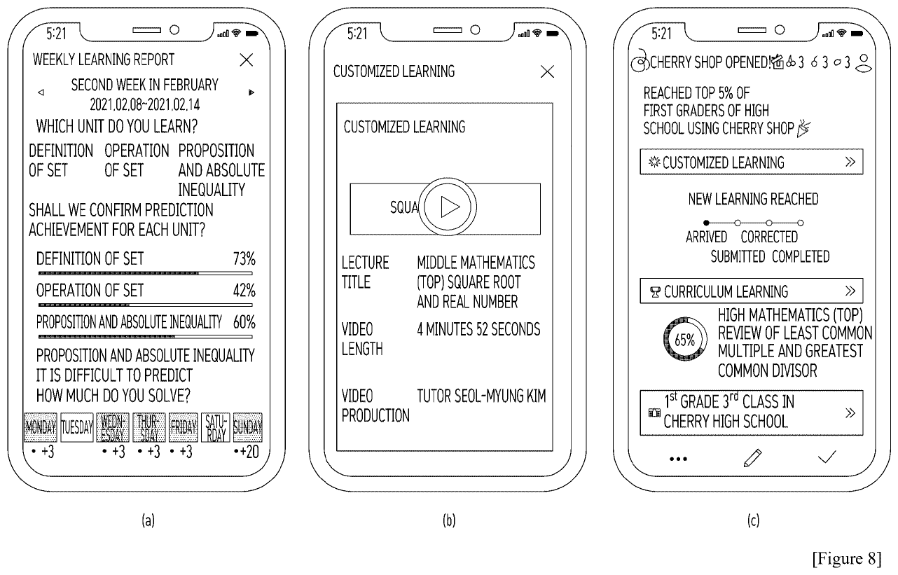

FIG. 8 is a diagram schematically illustrating a user interface that provides a synthetics result on a mathematics problem solving process according to an embodiment of the present disclosure.

According to an embodiment of the present disclosure, the computing device 100 may provide a learning performance, a customized learning, a personalized learning status, etc., as illustrated in FIG. 8(a). The computing device 100 may displays a learning achievement such as a content “reaching top 5%”, and this visually shows an achievement of the user to enhance a motivation. In addition, the computing device 100 provides a notification of “new learning has arrived!”, so the user may confirm a learning process during a specific period. Further, the computing device 100 displays a progress related to a recently learned subject (e.g., higher mathematics) and understanding degree information at a percent to allow the user to determine a learning progress situation and an understanding degree of the user. For example, the computing device 100 may also provide detailed information for individual lectures to be learned today as in FIG. 8(b). A title and an overview of a lecture to be learned today are introduced in a part marked as “concept lecture”, and the lecture title includes details related to a theme (e.g., “a least common multiple and a greatest common denominator”) to assist to clearly understand contents to be learned. Further, detailed lecture information includes detailed information such as a lecture length (42 minutes), so the user may plan a time required for the lecture. Further, a tutor name who provides the lecture (e.g., tutor Seol-myung Kim) may be displayed. Further, the user may immediately start the lecture through a central playback button, which is an interface element which helps to easily progress the learning process. For example, the computing device 100 may summarize and show a learning record for a week as illustrated in FIG. 8(c), and provide a learning performance of the user to be periodically reviewed. The computing device 100 may digitize and provide items such as a unit of learning, a prediction achievement for each unit, and a learning amount.

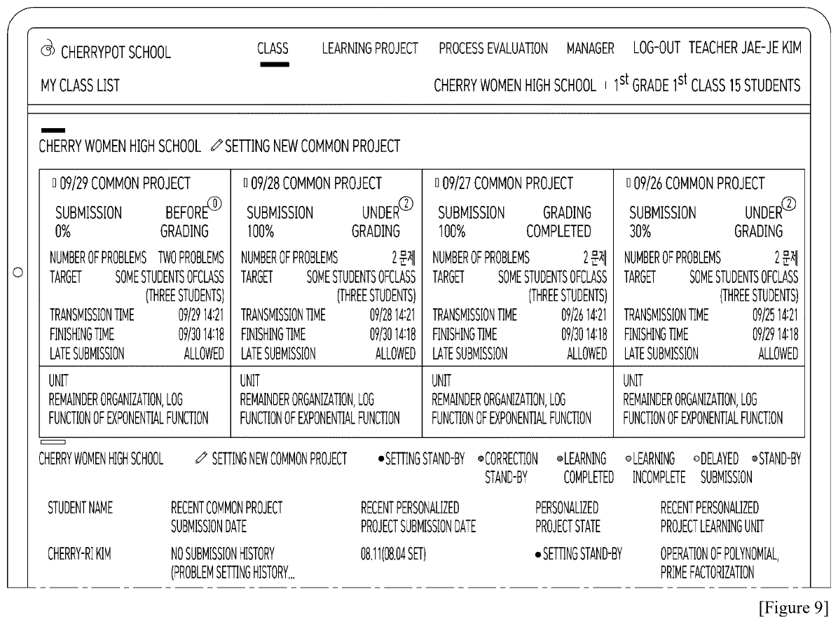

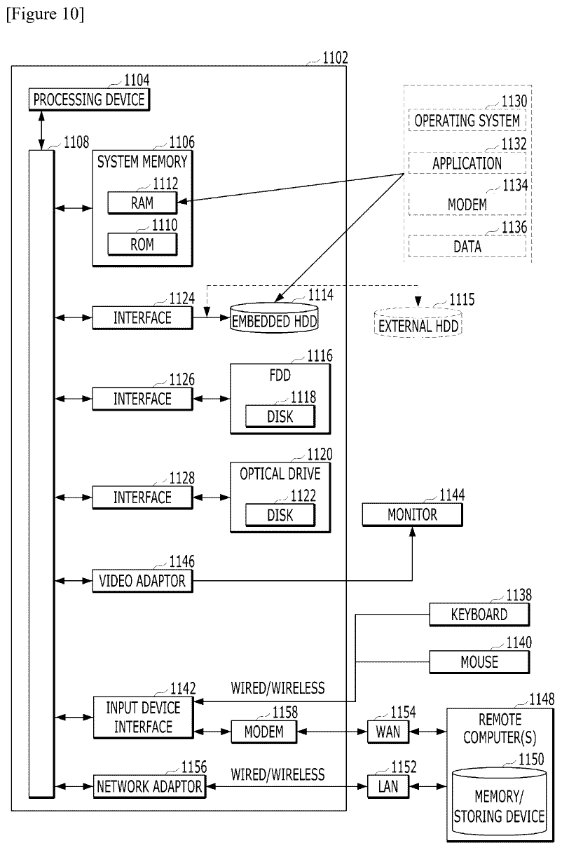

FIG. 9 is a diagram schematically illustrating a user interface related to a dashboard which may confirm a learning history for each student according to an embodiment of the present disclosure. For reference, FIG. 9 is a user interface screen of a dashboard for a teacher to efficiently manage and confirm a student-specific learning history. The user interface screen is configured so as to view a progress state of each project and submission statuses of individual projects of students, so the teacher may rapidly evaluate learning participation degrees and achievements of students.

The computing device 100 may display a list of a common project managed by the teacher for each date, and visually provide a submission state of each project. For example, when an item “09/29 common project” designated at a specific date is displayed as submission 0%, this means a state in which the corresponding project is not yet submitted, and when “09/28 common project” and “09/27 common project” are displayed as submission 100%, this indicates that all students submitted the corresponding project. Further, the computing device 100 may be configured so that a grading progress state of the project is displayed as “under grading”, “grading completed”, etc., in addition to the submission state in each project item, so the teacher may be configured to easily confirm a grading status. For example, the computing device 100 may provide the number of problems, a target student group, a submission start time, a submission finishing time, and whether late submission is allowed by including a project list in detailed project information. Through this, the teacher may clearly determine a project condition and a time limit, and provide a guideline appropriate to students based thereon. Moreover, each project includes linked learning unit information, so the teacher and the student may easily determine a unit which is being learned (e.g., remainder organization, an exponential function, and a log function) through the corresponding project. The computing device 100 provides the student-specific learning history to allow the teacher to comprehensively manage a learning status of each student. Individual student submission statuses may be displayed, and how frequently each student submits the common project and a submission state of the common project may be intuitively confirmed. For example, when there is no submission history of a specific student or a project submission ratio is low, the computing device 100 may help the teacher to easily recognize a need to encourage a project participation of the corresponding student. Further, the computing device 100 displays a personalized project state jointly to represent a personalized project progress situation of each student as “setting stand-by” or “grading stand-by”, and the teacher may systematically manage a learning progress of the student through the personalized project progress situation. Moreover, since recent learning unit information which each student is learning is also provided, the teacher may identify a learning unit which needs to be supplemented based on the learning history of the student, and use the identified learning unit as base data to provide an additional learning project based thereon.

Meanwhile, through a user interface related to a dashboard to confirm the student-specific learning history, the teacher may comprehensively analyze the student-specific learning history, and assist customized supervising suitable for the learning need of an individual student. The teacher may determine learning states of all classes by easily confirming submission and grading statuses of each project, and provide supplementary supervision or feedback based on a learning history and an understanding degree of the individual student.

The steps mentioned in the above description may be further split into additional steps, or combined into fewer steps according to an implementation example of the present disclosure. Further, some steps may also be omitted as necessary, and an order between the steps may be changed.

Disclosed is the computer readable medium storing the data structure according to an embodiment of the present disclosure. The above-described data structure may be stored in the memory in the present disclosure, executed by the processor, and transmitted and received by the network unit.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO—Last in First Out) in which the data is input last and output first. The queue is a data listing structure that may access data limitedly and unlike a stack, the queue may be a data structure (FIFO—First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

FIG. 7 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devicesas well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of anymedia among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them. The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

### MODE FOR INVENTION

Related contents in the best mode for carrying out the present disclosure are described as above.

1. A method for generating feedback information on a mathematical problem solution process, is the method performed by a computing device, the method comprising:
acquiring user input information related to a mathematical problem solution;
analyzing the mathematical problem solution process based on the acquired user input information by using a pretrained artificial intelligence model; and
generating feedback information for the mathematical problem solution based on the analysis.

2. The method of claim 1, wherein the acquiring the user input information related to the mathematical problem solution includes at least one of:
acquiring user input information input through an app or a web, or
acquiring user input information to scan a paper including information related to the mathematical problem solution.

3. The method of claim 1, wherein the acquiring the user input information related to the mathematical problem solution includes:
distinguishing characters, numbers, and mathematical symbols in the acquired user input information;
recognizing the distinguished character by using a character recognition model;
recognizing the distinguished number by using the character recognition model; and
recognizing the distinguished mathematical symbol by using the character recognition model.

4. The method of claim 1, wherein the analyzing the mathematical problem solution process based on the acquired user input information by using the pretrained artificial intelligence model includes:
sequentially dividing the solution process based on the acquired user input information; and
analyzing the sequentially divided solution process in response to a Rubric item by using the pretrained artificial intelligence model.

5. The method of claim 4, wherein the Rubric item includes at least one of a problem understanding, a solution approach, a calculation accuracy, or a final answer derivation.

6. The method of claim 4, wherein the pretrained artificial intelligence model is trained based on:
an operation of acquiring a training solution process data;
an operation of sequentially dividing the training solution process data;
an operation of acquiring the Rubric item which is an evaluation criterion for each of the sequentially divided training solution process data; and
an operation of predicting whether the sequentially divided training solution process data satisfies the Rubric item.

7. The method of claim 6, wherein the pretrained artificial intelligence model includes at least one of:
a first model for measuring an ability of identifying a purpose and a condition of a problem;
a second model for evaluating a solution access approach or a logical development;
a third model for evaluating a calculation accuracy for each of the sequentially divided training solution process data; or
a fourth model for determining whether a finally derived correct answer satisfies a requirement of problem.

8. The method of claim 4, wherein the generating the feedback information for the mathematical problem solution based on the analysis includes:
generating feedback information for the sequentially divided solution process based on a result analyzed in response to the Rubric item.

9. The method of claim 8, wherein the generating the feedback information for the sequentially divided solution process based on the result analyzed in response to the Rubric item includes at least one of:
generating feedback information for a solution process which needs to be improved in response to the Rubric item; or
generating the feedback information for the sequentially divided solution process by granting a partial score according to a satisfactory degree for each Rubric item.

10. The method of claim 1, wherein the analyzing the mathematical problem solution process based on the acquired user input information by using the pretrained artificial intelligence model includes:
analyzing whether the character included in the user input information is a character directly related to the mathematical problem solution or an additional character not directly related to the mathematical problem solution.

11. The method of claim 10, wherein the analyzing the mathematical problem solution process based on the acquired user input information by using the pretrained artificial intelligence model includes:
when the character included in the user input information is the character directly related to the mathematical problem solution, identifying a language character;
identifying a formula associated with the character among formulas included in the mathematical problem solution process by considering a system of the identified language; and
generating an analysis information based on a semantic information of the character and the identified formula.

12. The method of claim 10, wherein the analyzing the mathematical problem solution process based on the acquired user input information by using the pretrained artificial intelligence model includes:
when the character is the additional character not directly related to the mathematical problem solution, generating an analysis information based on a remaining part other than the additional character.

13. The method of claim 1, further comprising:
generating a problem related to the mathematical problem solution to be user customized by considering the analyzed mathematical problem solution process.

14. A computer program stored in a non-transitory computer-readable storage medium, wherein when the computer program is executed by one or more processors, the computer program allows the one or more processors to perform following operations for generating feedback information on a mathematical problem solution process, and the operations comprise:
an operation of acquiring user input information related to a mathematical problem solution;
an operation of analyzing the mathematical problem solution process based on the acquired user input information by using a pretrained artificial intelligence model; and
an operation of generating feedback information for the mathematical problem solution based on the analysis.

15. The computer program of claim 14, wherein the operation of acquiring the user input information related to the mathematical problem solution includes:
an operation of distinguishing characters, numbers, and mathematical symbols in the acquired user input information;
an operation of recognizing the distinguished character by using a character recognition model;
an operation of recognizing the distinguished number by using the character recognition model; and
an operation of recognizing the distinguished mathematical symbol by using the character recognition model.

16. The computer program of claim 14, wherein the operation of analyzing the mathematical problem solution process based on the acquired user input information by using a pretrained artificial intelligence model includes:
an operation of sequentially dividing the solution process based on the acquired user input information; and
an operation of analyzing the sequentially divided solution process in response to a Rubric item by using the pretrained artificial intelligence model.

17. A computing device comprising:
at least one processor; and
a memory,
wherein the at least one processor is configured to:
acquire user input information related to a mathematical problem solution;
analyze the mathematical problem solution process based on the acquired user input information by using a pretrained artificial intelligence model; and
generate feedback information for the mathematical problem solution based on the analysis.

18. The computing device of claim 17, wherein the at least one processor is configured to:
distinguish characters, numbers, and mathematical symbols in the acquired user input information;
recognize the distinguished character by using a character recognition model;
recognize the distinguished number by using the character recognition model; and
recognize the distinguished mathematical symbol by using the character recognition model.

19. The computing device of claim 17, wherein the at least one processor is configured to:
sequentially divide the solution process based on the acquired user input information; and
analyze the sequentially divided solution process in response to a Rubric item by using the pretrained artificial intelligence model.
